(19) United States
(12) Patent Application Publication
(10) Pub. No.: US 2017/0121469 A1
(43) Pub. Date: May 4, 2017

(54) POLYDIMETHYLSILOXANE CROSS-LINKING MATERIALS

(71) Applicant: International Business Machines Corporation, Armonk, NY (US)

(72) Inventors: Brandon M. Kobilka, Tucson, AZ (US); Joseph Kuczynski, North Port, FL (US); Phillip V. Mann, Rochester, MN (US); Jason T. Wertz, Pleasant Valley, NY (US)

(21) Appl. No.: 14/929,970

(22) Filed: Nov. 2, 2015

(51) Int. Cl. C08J 3/24

(52) U.S. Cl. CPC C08J 3/24; C08J 2383/04

(57) ABSTRACT

In an example, a process of forming a polymeric material includes forming a mixture that includes a polydimethylsiloxane (PDMS) material and a pentaerythritol cross-linking material. The process also includes forming a cross-linked PDMS material via a chemical reaction of the pentaerythritol cross-linking material and the PDMS material.

### I. FIELD OF THE DISCLOSURE

The present disclosure relates generally to polydimethylsiloxane (PDMS) cross-linking materials.

### II. BACKGROUND

Polydimethylsiloxane (PDMS) is among the widely used silicon-based polymers, and the most widely used organic silicon-based polymer. PDMS materials have a wide range of applications including contact lenses, medical devices, soft lithography processes, shampoos, caulking, and lubricants (among other alternatives). One reason for the wide-ranging applications for PDMS materials is the variety of ways in which the properties of PDMS may be controlled through polymer cross-linking. By employing PDMS and small organic molecules with different organic functional groups, many possibilities exist for different PDMS materials to be cross-linked in different ways.

### III. SUMMARY OF THE DISCLOSURE

According to an embodiment, a process of forming a polymeric material is disclosed. The process includes forming a mixture that includes a PDMS material and a pentaerythritol cross-linking material. The process also includes forming a cross-linked PDMS material via a chemical reaction of the pentaerythritol cross-linking material and the PDMS material.

According to another embodiment, a process of forming a polymeric material is disclosed. The process includes forming a mixture that includes a PDMS material and a pentaerythritol-derived cross-linking material. The process also includes forming a cross-linked PDMS material via a chemical reaction of the pentaerythritol-derived cross-linking material and the PDMS material.

According to another embodiment, a cross-linked PDMS material is disclosed. The cross-linked PDMS material is cross-linked using a pentaerythritol-based cross-linking material that is formed from bio-renewable pentaerythritol.

One advantage of the present disclosure is the ability to form cross-linked PDMS materials using pentaerythritol-based cross-linking materials, such as a bio-renewable pentaerythritol cross-linking material or a pentaerythritol-based cross-linking material derived from bio-renewable pentaerythritol. Utilizing bio-renewable pentaerythritol (or derivatives of bio-renewable pentaerythritol) as a cross-linking material may increase the bio-renewable content of a cross-linked PDMS material, for use in various applications.

Features and other benefits that characterize embodiments are set forth in the claims annexed hereto and forming a further part hereof. However, for a better understanding of the embodiments, and of the advantages and objectives attained through their use, reference should be made to the Drawings and to the accompanying descriptive matter.

### IV. BRIEF DESCRIPTION OF THE DRAWINGS

FIG. 1 is a chemical reaction diagram illustrating the preparation of a first cross-linked PDMS material using pentaerythritol (PE) as a cross-linking material, according to one embodiment;

FIG. 2 is a chemical reaction diagram illustrating the preparation of a second cross-linked PDMS material using PE as a cross-linking material, according to one embodiment;

FIG. 3 is a chemical reaction diagram illustrating the preparation of a third cross-linked PDMS material using a PE-based cross-linking material, according to one embodiment;

FIG. 4 is a chemical reaction diagram illustrating the preparation of a fourth cross-linked PDMS material using a PE-based cross-linking material, according to one embodiment;

FIG. 5 is a chemical reaction diagram illustrating the preparation of a fifth cross-linked PDMS material using a PE-based cross-linking material, according to one embodiment;

FIG. 6 is a chemical reaction diagram illustrating the preparation of a sixth cross-linked PDMS material using a PE-based cross-linking material, according to one embodiment;

FIG. 7 is a chemical reaction diagram illustrating the preparation of a seventh cross-linked PDMS material using a PE-based cross-linking material, according to one embodiment; and

FIG. 8 is a chemical reaction diagram illustrating the preparation of an eighth cross-linked PDMS material using a PE-based cross-linking material, according to one embodiment.

### V. DETAILED DESCRIPTION

The present disclosure describes cross-linked PDMS materials that are cross-linked using PE-based cross-linking materials and processes of forming cross-linked PDMS materials using PE-based cross-linking materials. As further described herein, in some cases, PE (e.g., bio-renewable PE) may be used as a cross-linking material. In other cases, a PE-derived material (e.g., a PE-based material derived from bio-renewable PE) may be used as the cross-linking material. Utilizing bio-renewable PE (or derivatives of bio-renewable PE) as a cross-linking material may increase the bio-renewable content of a cross-linked PDMS material, for use in various applications.

The PE-based cross-linkers of the present disclosure may be applied to PDMS for different applications. In some cases, curing may be performed during processing of a desired material, with a completely cross-linked polymer. In other cases, the cross-linkers may be mixed with PDMS but left in a partial or uncross-linked state that can be left to cross-link upon addition to the PDMS for a particular desired application (e.g., a caulking or coating application, among other alternatives).

In a particular embodiment, the PE cross-linking material includes bio-renewable PE. In some cases, bio-renewable PE may be commercially available. Alternatively, bio-renewable PE may be synthesized using various approaches. As an example, bio-renewable PE may be formed from a biomass source, such as lignin, wood pulp, or a combination thereof. As another example, bio-renewable PE may be formed via an alcohol-chemical route. To illustrate, ethanol may be oxidized to form acetaldehyde, an intermediate for the production of PE. As a further example, one or more bio-renewable PE esters may be hydrolyzed to form bio-renewable PE. As yet another example, shorter chain fatty acids may be used to form PE esters (which may be hydrolyzed to form bio-renewable PE). It will be appreciated that numerous methods may be employed to form a bio-renewable PE cross-linking material and/or a PE-derived bio-renewable cross-linking material. Further, the PE-derived cross-linking materials described herein may be formed from PE, bio-renewable PE, a second bio-renewable material (or materials), or a combination thereof.

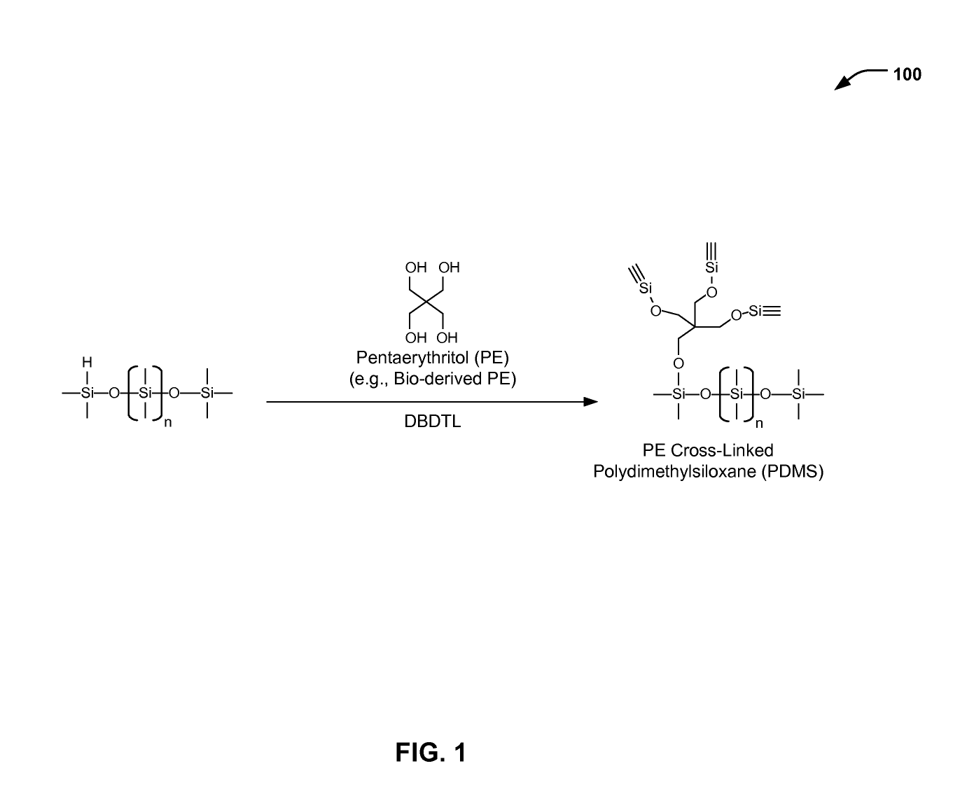

Referring to FIG. 1, a chemical reaction diagram 100 illustrates the preparation of a cross-linked PDMS material using PE (e.g., bio-renewable PE) as a cross-linking agent, according to one embodiment. In the example of FIG. 1, a mixture may be formed that includes a PDMS material (e.g., a hydride-functionalized siloxane) and PE cross-linking material. The cross-linked PDMS material illustrated in FIG. 1 may be formed via a chemical reaction (e.g., a condensation cure reaction) of the PE cross-linking material and the PDMS material. In the example of FIG. 1, dibutyltin dilaurate (DBTDL) may be used as a catalyst for the chemical reaction.

FIG. 1 illustrates an example in which all four hydroxyl groups of a single PE molecule are used as cross-linking sites. Depending on the reaction conditions, all four hydroxyl groups can be used to cross-link PDMS or, by controlling the reaction conditions, catalyst loading, and stoichiometry, a fraction of the hydroxyl groups (e.g., less than four hydroxyl groups per PE molecule, on average) can be used to cross-link PDMS. This may enable more control of the mechanical properties of the final polymer.

### Prophetic Example: Synthesis of a Cross-Linked PDMS Material Using PE (e.g., Bio-Renewable PE) as a Cross-Linking Material

As a prophetic example, a hydride-functionalized siloxane may be blended with a PE cross-linker (about 1-20% w/w) and catalyst (DBDTL in this case, 0.1%-2.0% w/w) and mixed. The mixture may be applied to molds or coated onto a substrate and cured for times and temperatures as appropriate for desired applications.

Thus, FIG. 1 illustrates an example of the preparation of a cross-linked PDMS material using PE as a cross-linking material. When the PE cross-linking material is derived from renewable resources, the bio-renewable content of a resulting cross-linked PDMS material may be increased.

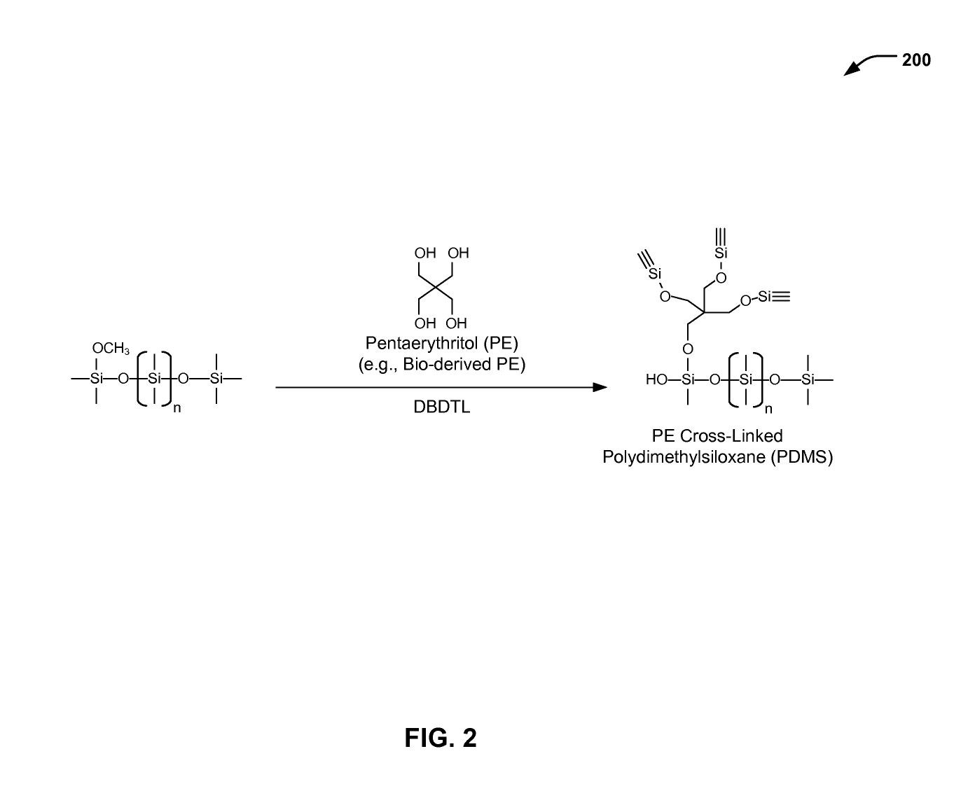

Referring to FIG. 2, a chemical reaction diagram 200 illustrates the preparation of a cross-linked PDMS material using PE (e.g., bio-renewable PE) as a cross-linking agent, according to one embodiment. In the example of FIG. 2, a mixture may be formed that includes a PDMS material (e.g., an alkoxy-functionalized siloxane, such as a methoxy-functionalized siloxane) and PE cross-linking material. The cross-linked PDMS material illustrated in FIG. 2 may be formed via a chemical reaction (e.g., a condensation cure reaction) of the PE cross-linking material and the PDMS material. In the example of FIG. 2, DBTDL may be used as a catalyst for the chemical reaction.

FIG. 2 illustrates an example in which all four hydroxyl groups of a single PE molecule are used as cross-linking sites. Depending on the reaction conditions, all four hydroxyl groups can be used to cross-link PDMS or, by controlling the reaction conditions, catalyst loading, and stoichiometry, a fraction of the hydroxyl groups (e.g., less than four hydroxyl groups per PE molecule, on average) can be used to cross-link PDMS. This may enable more control of the mechanical properties of the final polymer.

### Prophetic Example: Formation of a Cross-Linked PDMS Material Using PE (e.g., Bio-Renewable PE) as a Cross-Linking Material

As a prophetic example, an alkoxy-functionalized siloxane (e.g., a methoxy-functionalized siloxane) may be mixed with a PE cross-linker (1-20% w/w) and catalyst (DBDTL in this case, 0.1%-2.0% w/w). The mixture may be applied to molds or coated onto a substrate and cured for times and temperatures as appropriate for desired applications.

Thus, FIG. 2 illustrates an example of the preparation of a cross-linked PDMS material using PE as a cross-linking material. When the PE cross-linking material is derived from renewable resources, the bio-renewable content of a resulting cross-linked PDMS material may be increased.

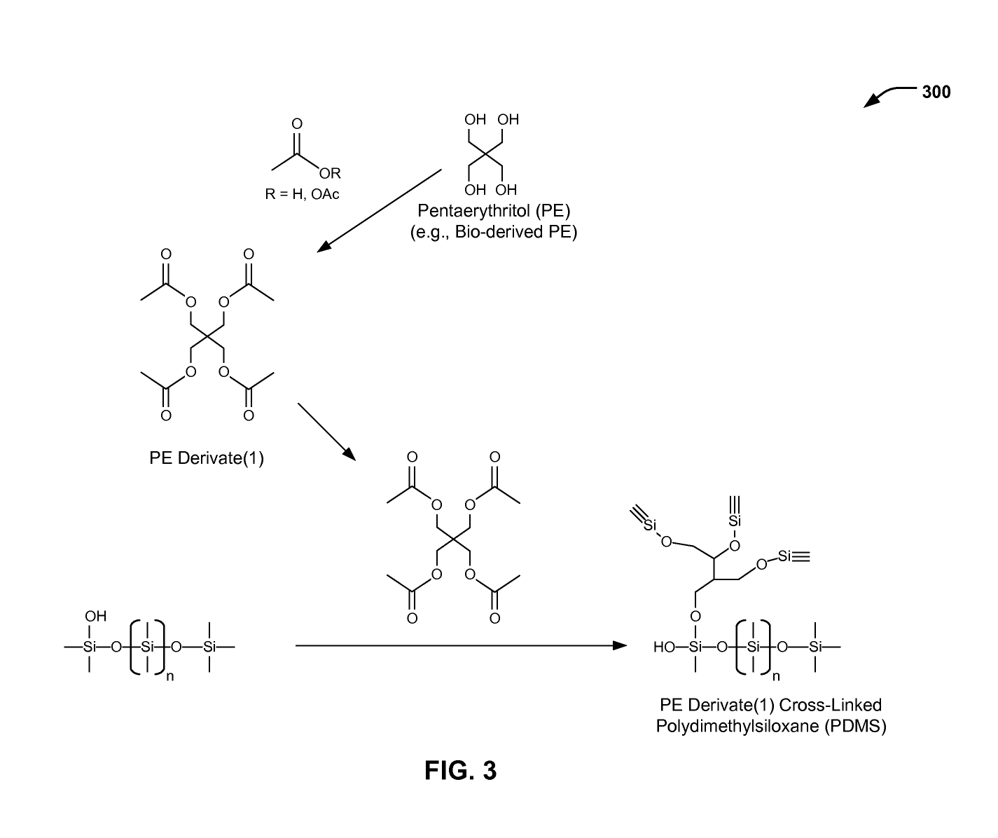

Referring to FIG. 3, a chemical reaction diagram 300 illustrates the preparation of a cross-linked PDMS material using a PE-derived cross-linking material (illustrated as “PE Derivate(1)” in FIG. 3), according to one embodiment. In some cases, the PE-derived cross-linking material of FIG. 3 may be formed from bio-renewable PE, bio-renewable acetic acid, or a combination thereof. In the example of FIG. 3, a mixture may be formed that includes a PDMS material (e.g., a hydroxy-functionalized siloxane) and PE-derived cross-linking material. The cross-linked PDMS material illustrated in FIG. 3 may be formed via a chemical reaction (e.g., a condensation cure reaction) of the PE-derived cross-linking material and the PDMS material.

FIG. 3 illustrates that PE (e.g., bio-renewable PE) may be chemically reacted with acetic acid or acetic anhydride via an acylation reaction to form a PE-based cross-linker with multiple acetate groups. In some cases, the acetic acid can be obtained from renewable sources. Further, acetic anhydride may be synthesized from bio-renewable acetic acid.

FIG. 3 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Synthesis of PE-Based Cross-Linking Material Via Esterification of PE (e.g., Bio-Renewable PE)

As a prophetic example, pentaerythritol (1 equiv.), acetic acid (4.5-5.0 equiv.), catalytic p-toluenesulfonic acid (or other catalysts such as sulfonic acids, sulfuric acid, phosphoric acid, hydrogen sulfates, dihydrogen phosphates, phosphonic acid esters, or dialkyl tin dioxides), and a suitable amount of toluene (or other water-azeotrope forming solvents) may be added to a reaction vessel and heated under azeotropic distillation conditions (e.g., refluxing using a Dean-Stark apparatus) until water is no longer removed from the reaction. The mixture may be cooled to room temperature, and the organic layer may be separated, rinsed with water, dried and purified.

### Prophetic Example: Formation of a Cross-Linked PDMS Material Using PE-Based Cross-Linking Material

As a prophetic example, a Si—OH functionalized siloxane may be blended with an acetoxy-PE cross-linker (1-50% w/w) and blended with exclusion of moisture. The blended mixture may be stored under moisture-free conditions. The blended mixture may be applied to surfaces and materials and allowed to cure under atmospheric conditions.

Thus, FIG. 3 illustrates an example of the preparation of a cross-linked PDMS material using a PE-derived cross-linking material. When the PE-derived cross-linking material of FIG. 3 is derived from renewable resources, the bio-renewable content of a resulting cross-linked PDMS material may be increased.

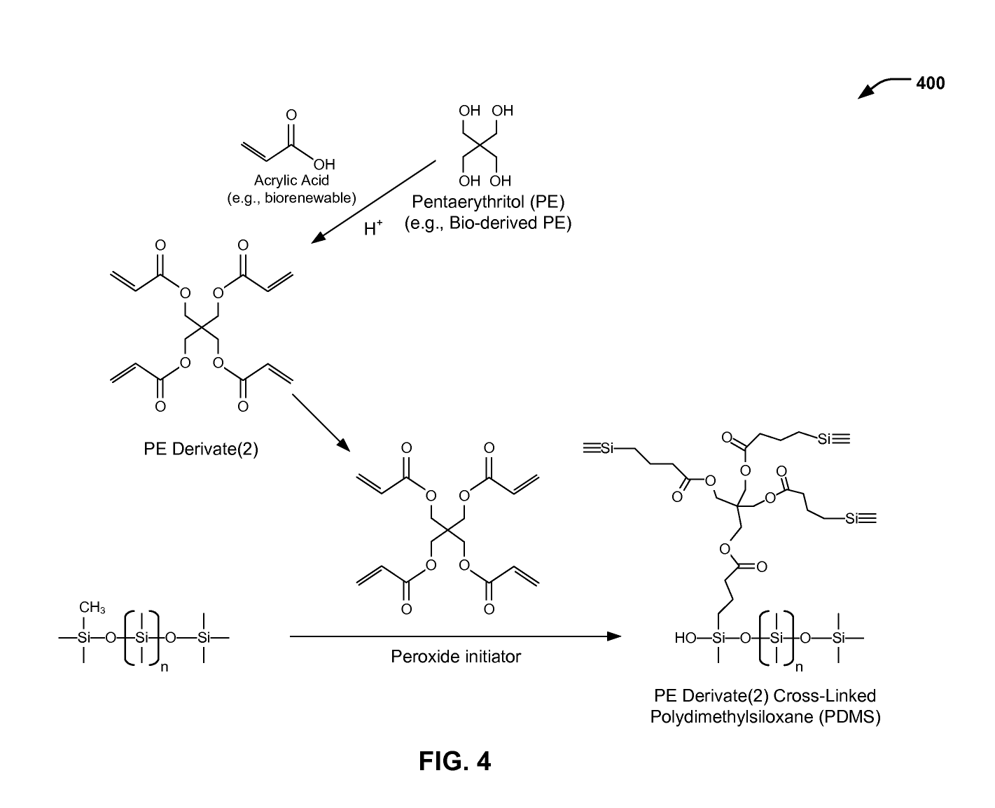

Referring to FIG. 4, a chemical reaction diagram 400 illustrates the preparation of a cross-linked PDMS material using a PE-derived cross-linking material (illustrated as “PE Derivate(2)” in FIG. 4), according to one embodiment. In some cases, the PE-derived cross-linking material of FIG. 4 may be formed from bio-renewable PE, bio-renewable acrylic acid, or a combination thereof. In the example of FIG. 4, a mixture may be formed that includes a PDMS material (e.g., a Si—CH₃ functional siloxane) and PE-derived cross-linking material. The cross-linked PDMS material illustrated in FIG. 4 may be formed via a chemical reaction (e.g., a radical cure reaction using a peroxide initiator) of the PE-derived cross-linking material and the PDMS material.

FIG. 4 illustrates that PE (e.g., bio-renewable PE) may be chemically reacted with acrylic acid via an acid (or base) catalyzed condensation reaction to form a PE-based cross-linker with multiple vinyl groups. In some cases, the acrylic acid can be obtained from renewable sources.

FIG. 4 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Synthesis of PE-Based Cross-Linking Material Via Esterification of PE (e.g., Bio-Renewable PE)

As a prophetic example, pentaerythritol (1 equiv.), acrylic acid (4.5-5.0 equiv.), catalytic p-toluenesulfonic acid (or other catalysts such as sulfonic acids, sulfuric acid, phosphoric acid, hydrogen sulfates, dihydrogen phosphates, phosphonic acid esters, or dialkyl tin dioxides), and a suitable amount of toluene (or other water-azeotrope forming solvents) may be added to a reaction vessel and heated under azeotropic distillation conditions (e.g., refluxing using a Dean-Stark apparatus) until water is no longer removed from the reaction. The mixture may be cooled to room temperature, and the organic layer may be separated, rinsed with water, dried and purified.

### Prophetic Example: Formation of a Cross-Linked PDMS Material Using a PE-Based Cross-Linking Material

As a prophetic example, a Si—CH₃ functional siloxane may be blended with a vinyl-PE cross-linker (1-20% w/w) and catalyst (e.g., benzoyl peroxide, 0.2%-1.0% w/w) and mixed. The mixture may be applied to molds or coated onto a substrate and cured for times and temperatures (e.g., 140-160° C., with a post cure of 25-30° C. higher than the initial reaction temperature to remove volatile peroxides) as appropriate for desired applications.

Thus, FIG. 4 illustrates another example of the preparation of a cross-linked PDMS material using a PE-derived cross-linking material. When the PE-derived cross-linking material of FIG. 4 is derived from renewable resources, the bio-renewable content of a resulting cross-linked PDMS material may be increased.

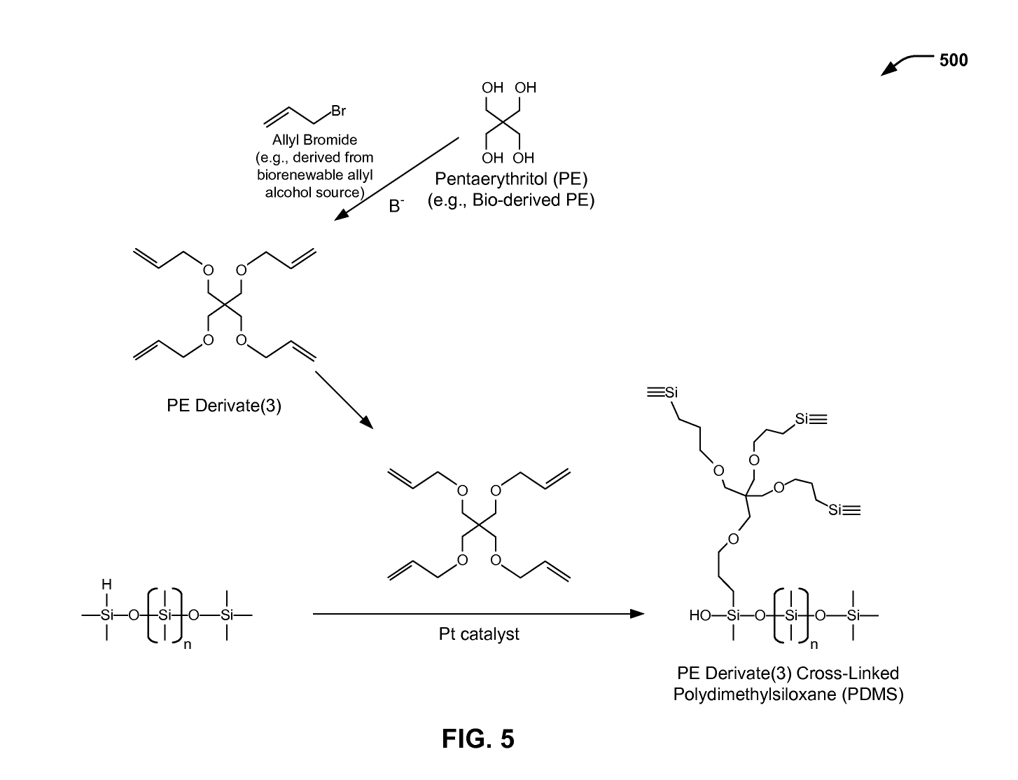

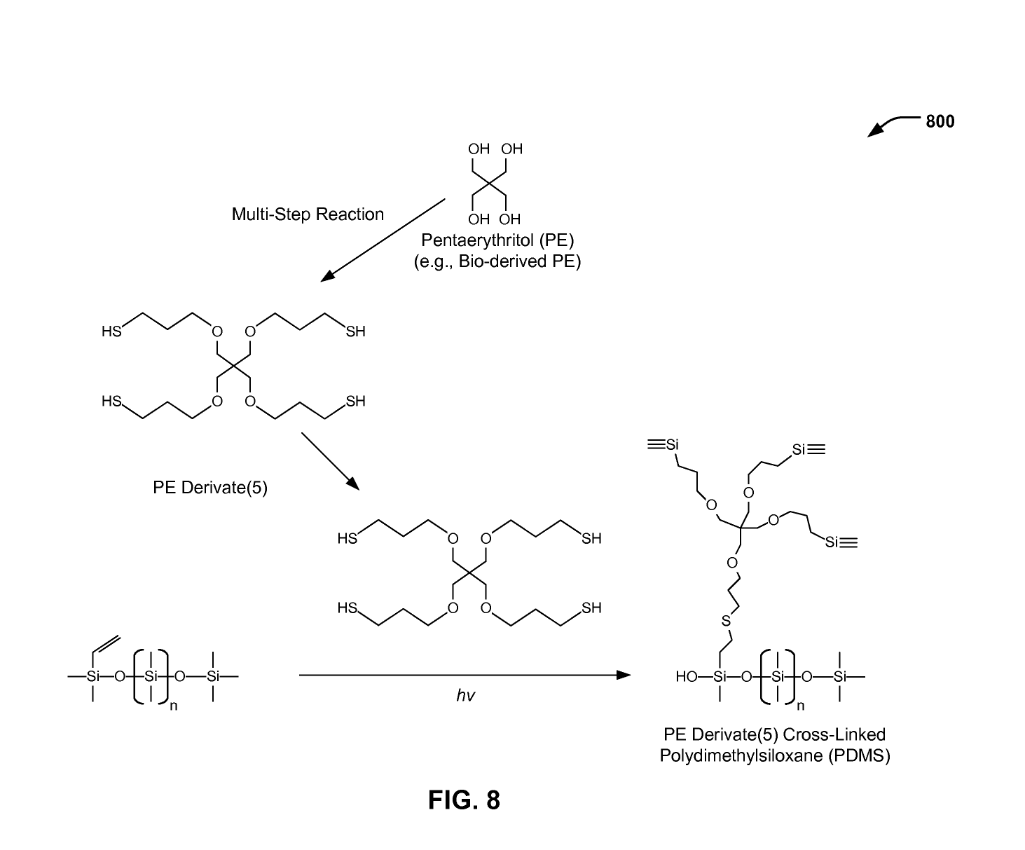

Referring to FIG. 5, a chemical reaction diagram 500 illustrates the preparation of a cross-linked PDMS material using a PE-derived cross-linking material (illustrated as “PE Derivate(3)” in FIG. 5), according to one embodiment. In some cases, the PE-derived cross-linking material of FIG. 5 may be formed from bio-renewable PE, an allyl bromide derived from a bio-renewable allyl alcohol, or a combination thereof. In the example of FIG. 5, a mixture may be formed that includes a PDMS material (e.g., a hydride-functionalized siloxane) and PE-derived cross-linking material. The cross-linked PDMS material illustrated in FIG. 5 may be formed via a chemical reaction (e.g., an addition cure reaction with a platinum catalyst) of the PE-derived cross-linking material and the PDMS material. As described further herein, the PE-derived cross-linking material illustrated in FIG. 5 may be used to synthesize the PE-derived cross-linking material of FIG. 8.

FIG. 5 illustrates that PE (e.g., bio-renewable PE) may be chemically reacted with allyl bromide via a substitution reaction to form a PE-based cross-linker with multiple vinyl groups (that is different from the PE-based cross-linker with multiple vinyl groups shown in FIG. 4). In some cases, the allyl bromide may be synthesized from a bio-renewable allyl alcohol.

FIG. 5 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Synthesis of PE-Based Cross-Linking Material

As a prophetic example, tetrakis(allyl)pentaerythritol ether may be synthesized by adding pentaerythritol (1 equiv.) and dimethylsulfoxide (11 equiv.) to a reaction vessel equipped with a condenser and a mechanical stirrer. The vessel may be heated to about 80° C., and sodium oxide (4.4 equiv.) may be added to the reaction mixture, causing the reaction temperature to increase slightly. Once the temperature has returned to 80° C., the reaction vessel may be purged with nitrogen, and allyl chloride (4.4 equiv.) may be added slowly to the reaction mixture as to maintain a temperature below about 90° C. Upon completion of the addition, the reaction mixture may be stirred at about 85° C. for about 2 hours. The reaction mixture may be diluted with water, cooled and extracted with diethyl ether. The organic solvents may be removed in vacuo, and the product may be purified by distillation or other techniques.

### Prophetic Example: Formation of a Cross-Linked PDMS Material Using a PE-Based Cross-Linking Material

As a prophetic example, a hydride-functional siloxane may be blended with a vinyl-PE cross-linker (1-20% w/w) and Pt catalyst and mixed. An addition cure reaction via hydrosilation may be performed on the mixture.

Thus, FIG. 5 illustrates another example of the preparation of a cross-linked PDMS material using a PE-derived cross-linking material. When the PE-derived cross-linking material of FIG. 5 is derived from renewable resources, the bio-renewable content of a resulting cross-linked PDMS material may be increased.

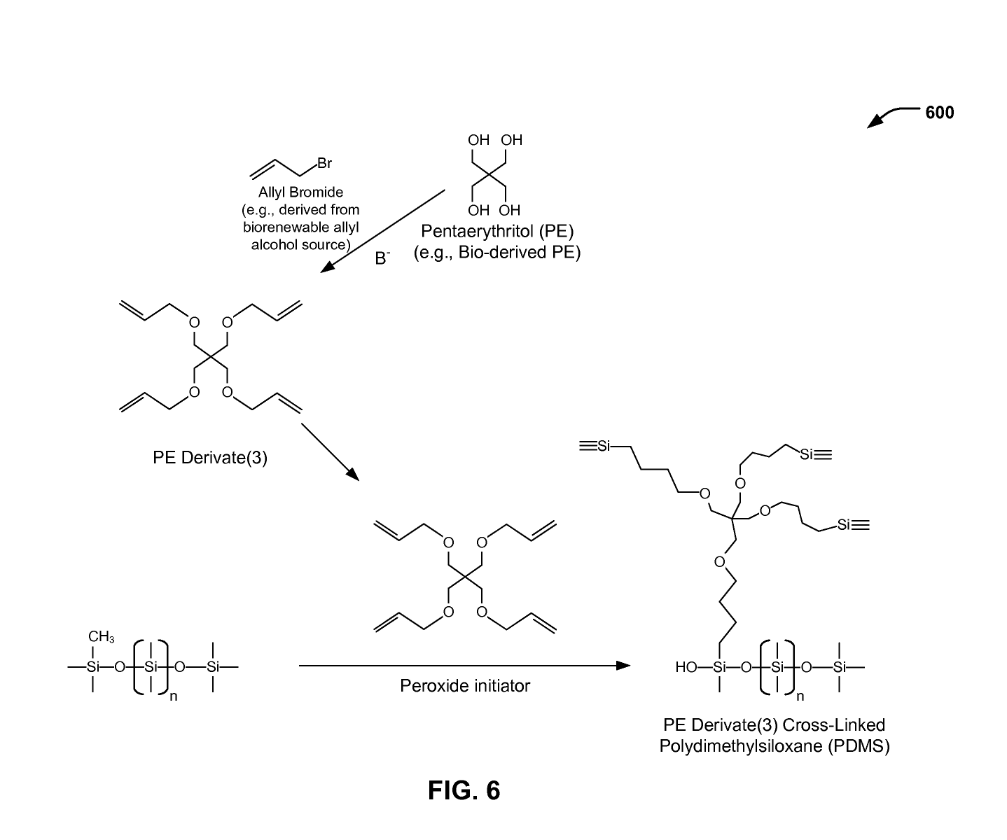

Referring to FIG. 6, a chemical reaction diagram 600 illustrates the preparation of a cross-linked PDMS material using the PE-derived cross-linking material of FIG. 5, according to one embodiment. In the example of FIG. 6, a mixture may be formed that includes a PDMS material (e.g., a Si—CH₃ functional siloxane) and PE-derived cross-linking material. The cross-linked PDMS material illustrated in FIG. 6 may be formed via a chemical reaction (e.g., an addition/peroxide cure reaction) of the PE-derived cross-linking material and the PDMS material.

FIG. 6 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Formation of a Cross-Linked PDMS Material Using a PE-Based Cross-Linking Material

As a prophetic example, a Si—CH₃ functional siloxane may be blended with vinyl-PE cross-linker (1-20% w/w) and catalyst (e.g., benzoyl peroxide, 0.2%-1.0% w/w) and mixed. The mixture may be applied to molds or coated onto a substrate and cured for times and temperatures (e.g., 140-160° C., with a post cure of 25-30° C. higher than the initial reaction temperature to remove volatile peroxides) as appropriate for desired applications.

Thus, FIG. 6 illustrates another example of the preparation of a cross-linked PDMS material using the PE-derived cross-linking material of FIG. 5. When the PE-derived cross-linking material is derived from renewable resources, the bio-renewable content of a resulting cross-linked PDMS material may be increased.

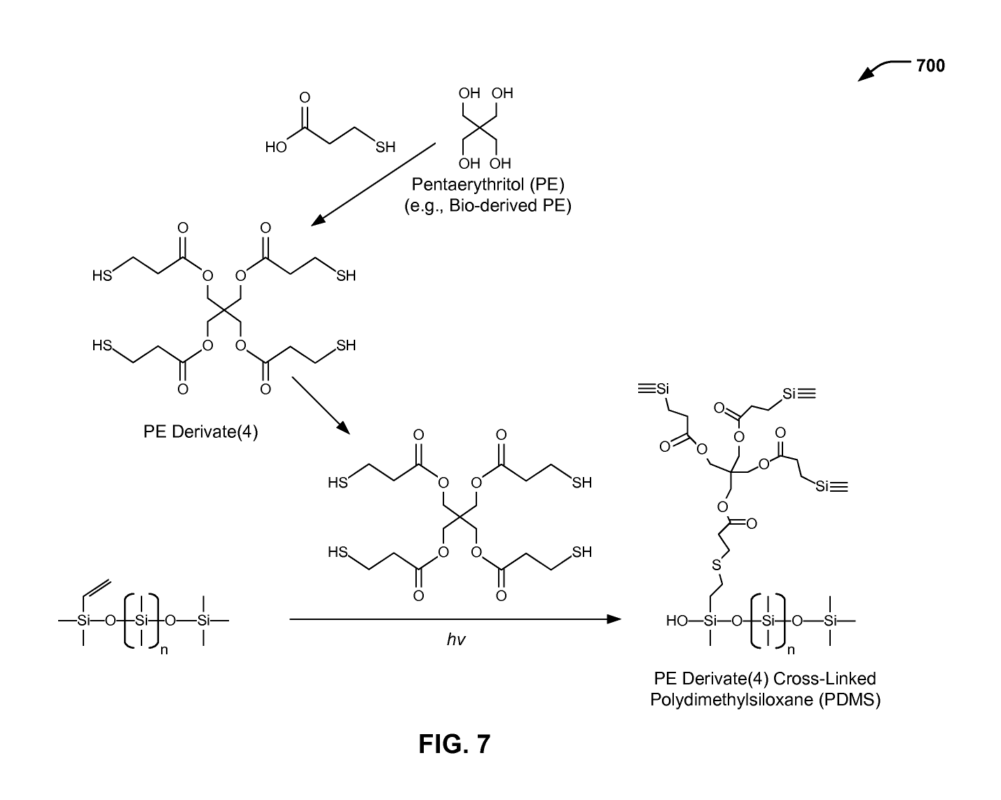

Referring to FIG. 7, a chemical reaction diagram 700 illustrates the preparation of a cross-linked PDMS material using a PE-derived cross-linking material (illustrated as “PE Derivate(4)” in FIG. 7), according to one embodiment. In some cases, the PE-derived cross-linking material of FIG. 6 may be formed from bio-renewable PE, a mercaptoic acid derived from bio-renewable acrylic acid, or a combination thereof. In the example of FIG. 7, a mixture may be formed that includes a PDMS material (e.g., a vinyl-functionalized siloxane) and PE-derived cross-linking material. The cross-linked PDMS material illustrated in FIG. 7 may be formed via a chemical reaction (e.g., a thiol-ene cure reaction) of the PE-derived cross-linking material and the PDMS material.

FIG. 7 illustrates that PE (e.g., bio-renewable PE) may be chemically reacted with ethyl mercaptoacetic acid via a condensation reaction (acid/base promoted) to synthesize a cross-linker with multiple thiol (or mercapto) groups. In some case, the ethyl mercaptoic acid can be synthesized from bio-renewable acrylic acid via subsequent halogenation and substitution reactions.

FIG. 7 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Synthesis of PE-Based Cross-Linking Material Via Esterification of PE (e.g., Bio-Renewable PE)

As a prophetic example, pentaerythritol (1 equiv.), 3-mercaptopropionic acid (4.5-5.0 equiv.), catalytic p-toluenesulfonic acid (or other catalysts such as sulfonic acids, sulfuric acid, phosphoric acid, hydrogen sulfates, dihydrogen phosphates, phosphonic acid esters, or dialkyl tin dioxides), and a suitable amount of toluene (or other water-azeotrope forming solvents) may be added to a reaction vessel and heated under azeotropic distillation conditions (e.g., refluxing using a Dean-Stark apparatus) until water is no longer removed from the reaction. The mixture may be cooled to room temperature, and the organic layer may be separated, rinsed with water, dried and purified.

### Prophetic Example: Formation of a Cross-Linked PDMS Material Using a PE-Based Cross-Linking Material

As a prophetic example of a thiol-ene cure of a thiol-functionalized PE with a vinyl-siloxane, a thiol-PE cross-linker (2-6% w/w) may be mixed with a vinyl-functionalized siloxane. The mixture may include a radical initiator, such as a Micheler's ketone, an alpha-amino-ketone, an alpha-hydroxy-ketone, a benzyldimethyl ketal, or benzophenone (among other alternatives). The mixture may be applied to molds or coated onto a substrate and cured under UV light at a time and temperature suitable to the included radical initiators as appropriate for desired applications.

Thus, FIG. 7 illustrates another example of the preparation of a cross-linked PDMS material using a PE-derived cross-linking material. When the PE-derived cross-linking material of FIG. 7 is derived from renewable resources, the bio-renewable content of a resulting cross-linked PDMS material may be increased.

Referring to FIG. 8, a chemical reaction diagram 800 illustrates the preparation of a cross-linked PDMS material using a PE-derived cross-linking material (illustrated as “PE Derivate(5)” in FIG. 8), according to one embodiment. In some cases, the PE-derived cross-linking material of FIG. 8 may be formed from bio-renewable PE, a mercaptoic acid derived from bio-renewable acrylic acid, an allyl bromide derived from a bio-renewable allyl alcohol (as described herein with respect to FIG. 5), or a combination thereof. In the example of FIG. 8, a mixture may be formed that includes a PDMS material (e.g., a vinyl-functionalized siloxane) and PE-derived cross-linking material. The cross-linked PDMS material illustrated in FIG. 8 may be formed via a chemical reaction (e.g., a thiol-ene cure reaction) of the PE-derived cross-linking material and the PDMS material.

FIG. 8 illustrates that PE (e.g., bio-renewable PE) may be chemically reacted with an allyl bromide (see FIGS. 5 and 6) via a substitution reaction, followed by halogenation and thiol substitution reactions (similar to FIG. 7) to form a cross-linker with multiple thiol (mercapto) groups.

FIG. 8 illustrates an example in which all four functional groups of a single PE-based cross-linking molecule are used as cross-linking sites. Depending on the reaction conditions, all four functional groups can be used to cross-link PDMS or, by controlling the reaction conditions, catalyst loading, and stoichiometry, a fraction of the functional groups (e.g., less than four functional groups per PE-based molecule, on average) can be used to cross-link PDMS. This may enable more control of the mechanical properties of the final polymer.

### Prophetic Example: Synthesis of PE-Based Cross-Linking Material

As a prophetic example, tetrakis(propanethiol)pentaerythritol may be synthesized using tetrakis(allyl)pentaerythritol ether (illustrated in FIGS. 5 and 6). To a stirred solution of tetrakis(allyl)pentaerythritol ether (1 equiv.), in benzene or DCM (or another suitable solvent for radical reactions), a catalytic amount of benzoyl peroxide (BPO) (or other radical initiators, such as azobisisobutyronitrile (AIBN)), and hydrobromic acid (>4 equiv.) may be added. The reaction may be heated to reflux (optionally activated by UV light) until complete. The reaction may be quenched with water, and the organic layer may be separated and dried, and the solvents may be removed in vacuo. The product may be purified by vacuum distillation or by other techniques.

To a stirred solution of tetrakis(bromopropane)pentaerythritol ether (1 equiv., the product from the previous reaction) in ethanol is added thiourea (>4 equiv.). The reaction mixture may be heated to reflux and stirred for about 6-24 hours or until complete conversion. The reaction may be cooled slightly, and the ethanol may be removed under reduced pressure. To the resulting salt, an excess amount of a solution of aqueous sodium hydroxide (10% w/w) may be added. The solution may be refluxed for about 3 hours or until the reaction is complete. The reaction mixture may be neutralized with dilute hydrochloric acid, extracted with diethyl ether, and the solvents may be removed in vacuo. The product may be purified by vacuum distillation or by other techniques.

### Prophetic Example: Formation of a Cross-Linked PDMS Material Using a PE-Based Cross-Linking Material

As a prophetic example of a thiol-ene cure of a thiol-functionalized PE with a vinyl-functionalized siloxane, a thiol-PE cross-linker (2-6% w/w) may be mixed with a vinyl-functionalized siloxane. The mixture may include a radical initiator, such as a Micheler's ketone, an alpha-amino-ketone, an alpha-hydroxy-ketone, a benzyldimethyl ketal, or benzophenone (among other alternatives). The mixture may be applied to molds or coated onto a substrate and cured under UV light at a time and temperature suitable to the included radical initiators as appropriate for desired applications.

Thus, FIG. 8 illustrates another example of the preparation of a cross-linked PDMS material using a PE-derived cross-linking material. When the PE-derived cross-linking material of FIG. 8 is derived from renewable resources, the bio-renewable content of a resulting cross-linked PDMS material may be increased.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and features as defined by the following claims.

1. A process of forming a polymeric material, the process comprising:
forming a mixture that includes a polydimethylsiloxane (PDMS) material and a pentaerythritol cross-linking material; and
forming a cross-linked PDMS material via a chemical reaction of the pentaerythritol cross-linking material and the PDMS material.

2. The process of claim 1, wherein the pentaerythritol cross-linking material includes bio-renewable pentaerythritol.

3. The process of claim 1, wherein the PDMS material includes a hydridefunctionalized PDMS material, and wherein the chemical reaction includes a condensation cure reaction using dibutyltin dilaurate (DBDTL) as a catalyst.

4. of claim 1, wherein the PDMS material includes an alkoxyfunctionalized PDMS material, and wherein the chemical reaction includes a condensation cure reaction using dibutyltin dilaurate (DBDTL) as a catalyst.

5. The process of claim 4, wherein the alkoxy-functionalized PDMS material includes a methoxy-functionalized PDMS material.

6. A process of forming a polymeric material, the process comprising:
forming a mixture that includes a polydimethylsiloxane (PDMS) material and a pentaerythritol-derived cross-linking material; and
forming a cross-linked PDMS material via a chemical reaction of the pentaerythritol-derived cross-linking material and the PDMS material.

7. The process of claim 6, wherein the pentaerythritol-derived cross-linking material is formed from bio-renewable pentaerythritol and a second bio-renewable material.

8. The process of claim 6, wherein the pentaerythritol-derived cross-linking material includes multiple acetate groups.

9. The process of claim 8, wherein the PDMS material includes a hydroxyfunctionalized PDMS material.

10. The process of claim 6, wherein the pentaerythritol-derived cross-linking material includes multiple vinyl groups.

11. The process of claim 10, wherein the chemical reaction includes a radical cure reaction using a peroxide initiator.

12. The process of claim 10, wherein the chemical reaction includes an addition cure reaction using a platinum catalyst.

13. The process of claim 6, wherein the pentaerythritol-derived cross-linking material includes multiple thiol groups.

14. The process of claim 12, wherein the PDMS material includes a vinylfunctionalized PDMS material, and wherein the chemical reaction includes a thiol-ene cure reaction.

15. A cross-linked polydimethylsiloxane (PDMS) material that is cross-linked using a pentaerythritol-based cross-linking material that is formed from bio-renewable pentaerythritol.

16. The cross-linked PDMS material of claim 15, wherein the pentaerythritol based cross-linking material includes the bio-renewable pentaerythritol.

17. The cross-linked PDMS material of claim 15, wherein the pentaerythritol based cross-linking material is formed via a chemical reaction of the bio-renewable pentaerythritol and a second material, the second material including bio-renewable acetic acid or an acetic anhydride that is derived from bio-renewable acetic acid.

18. The cross-linked PDMS material of claim 15, wherein the pentaerythritol based cross-linking material is formed via a chemical reaction of the bio-renewable pentaerythritol and bio-renewable acrylic acid.

19. The cross-linked PDMS material of claim 15, wherein the pentaerythritolbased cross-linking material is formed via a chemical reaction of the bio-renewable pentaerythritol and an allyl bromide that is derived from a bio-renewable allyl alcohol.

20. The cross-linked PDMS material of claim 15, wherein the pentaerythritol based cross-linking material is formed via a chemical reaction of the bio-renewable pentaerythritol and ethyl mercaptoic acid, wherein the ethyl mercaptoic acid is formed from a bio-renewable acrylic acid.
